(19) United States
(12) Patent Application Publication
(10) Pub. No.: US 2025/0066933 A1
(43) Pub. Date: Feb. 27, 2025

(54) MODULAR ELECTROCHEMICAL SYSTEM

(71) Applicant: Enapter S.r.l., Pisa (IT)

(72) Inventors: Thorben BUSCH, Saerbeck (DE); Kai LOUDON, Saerbeck (DE); Jan-Justus SCHMIDT, Saerbeck (DE); Holger EISENLOHR, Saerbeck (DE); Thomas CHROMETZKA, Saerbeck (DE)

(21) Appl. No.: 18/723,336

(22) PCT Filed: Dec. 22, 2022
(86) PCT No.: PCT/EP2022/087506

§ 371 Date: Jun. 21, 2024

(30) Foreign Application Priority Data
Dec. 22, 2021 (GB) 2118852.9

(51) Int. Cl. C25B 9/70; C25B 1/04; C25B 9/19; C25B 15/08

(52) U.S. Cl. CPC C25B 9/70; C25B 1/04; C25B 9/19; C25B 15/08

(57) ABSTRACT

A modular electrochemical system, said system comprising: one or more electrochemical blades, wherein each electrochemical blade comprises at least one electrochemical stack, and one or more balance of plant (BOP) blades, wherein each BOP blade comprises at least one BOP facility for at least one electrochemical stack, wherein the or each electrochemical blade(s) corresponds to any one or more of the BOP blades, and vice versa, and each electrochemical and/or BOP blade is provided with a framework, said framework comprising at least one port adapted to enable connection with one or more corresponding blades.

### FIELD OF INVENTION

The present invention relates to an improved means and method for providing a modular electrochemical system including but not necessarily limited to electrolysers and the requisite balance of plant (BOP).

### BACKGROUND

Electrochemistry is the branch of chemistry pertaining to the relationships between electrical and chemical phenomena. Originating in the early 1800s with the advent of the first modern electrical battery developments over the following decades have been made. The present document is particularly interested in electrochemical cells, groups of which collectively form a stack, and the BOP to run it.

Hydrogen has a multitude of applications, ranging from energy storage to the production of fertilisers. Hydrogen can be derived from many sources. Some of these sources, such as fossil fuels, are undesirable for obvious reasons. Therefore, there is a need to be able to produce hydrogen in a reliable and sustainable manner. Electrochemistry provides a green alternative.

Electrolysers are devices used for the generation of hydrogen and oxygen by splitting water. It is possible to power such devices with excess renewable energy, using hydrogen as a means for energy storage as opposed to batteries, for example. Electrolysers generally fall in one of three main technologies currently available, namely anion exchange membrane (AEM), proton exchange membrane (PEM), and liquid alkaline systems. Liquid alkaline systems are the most established technology, with PEM being somewhat established. AEM electrolysers are a relatively new technology. Other technologies, such as solid oxide electrolysis are available.

AEM and PEM electrolysers are reliant on the transfer of ions from one half-cell to the other for the generation of hydrogen. AEM systems rely on the movement of hydroxide ions, OH, whilst PEM systems rely on the movement of hydrogen ions, H⁺.

Other electrochemical devices include fuel cells, electrochemical compressors, or electrochemical purification devices. Each of these may be used alone, but can also be found to form part of a single hydrogen solution.

At present, it is common practice to size a single electrochemical stack for the purpose required. However, a common drawback for such activity is that the required activation energy for each stack, especially of such a size, means that when less power is available the stack is not operated. The result is underutilization of available energy, and a reduced ability to respond to power fluctuations. At present, it is also common practice to provide a custom BOP for the stacks based on the requirements of the particular stacks. This becomes cumbersome when multiple stacks are being used, and often means additional design considerations must be taken into account on a project-by-project basis because the BOP requirements different stacks are likely to be different.

An object of the present invention is to provide an improved means and method for providing a modular electrochemical system including but not necessarily limited to electrolysers and the requisite balance of plant (BOP).

### SUMMARY OF THE INVENTION

Aspects and embodiments of the present invention are set out in the appended claims. These and other aspects and embodiments of the invention are also described herein.

According to the present invention there is provided a modular electrochemical system, said system comprising:
One or more electrochemical blades, wherein each electrochemical blade comprises at least one or more electrochemical stacks, and
One or more balance of plant (BOP) blades, wherein each BOP blade comprise at least one BOP facility for at least one electrochemical stack, wherein
   The or each electrochemical blade(s) correspond to any one or more of the BOP blades, and vice versa, and
Each electrochemical and/or BOP blade is provided with a framework, said framework comprising ports adapted to enable connection with one or more corresponding blades.

As used herein, the term “electrochemical stack” is preferably intended to include any stack of electrochemical cells, or a single electrochemical cell, including but not limited to electrolysers, fuel cells, or compressors. In the preferred embodiment electrolysers, particularly AEM electrolysers, are the electrochemical stack.

As used herein, the term “framework” is preferably intended to refer to a spatial configuration, and more preferably to a physical frame or housing providing the spatial configuration, including anything from a barebones frame for grouping a plurality of components to a weatherproof housing with substantially solid walls, floor, and roof.

As used herein, the term “electrochemistry” preferably refers to hydrogen. However, the present invention is not intended to be limited to the electrochemistry of hydrogen, and the same means may be provided for other types of electrochemical stacks.

As used herein, the terms “blades” and “strings” may be used interchangeably to mean a grouping of electrochemical cells, stacks, or modules, a “module” being a housing within the blade/string comprising (preferably containing) a stack.

As used herein, use of the term “electrolyser” when discussing system architecture is not intended to exclude other types of electrochemical stacks where their use may be appropriate.

As used herein, the term “balance of plant” (BOP) is preferably used to refer to the ancillary components of the electrochemical system which support the electrochemical processes of the system. For example, where the electrochemical system is an electrolyser for producing hydrogen, the balance of plant is the ancillary components that facilitate and support the production of hydrogen, other than the hydrogen producing components themselves. Exemplary BOP components are listed below.

It is envisaged that any electrochemical cell or stack thereof may be used in accordance with the present invention. However, in the preferred embodiment the electrochemical cell is at least one of: an electrolyser, a fuel cell, an electrochemical purifier, or an electrochemical compressor. Preferably in embodiments using an electrolyser, said electrolyser is an AEM electrolyser. More preferably still the AEM electrolyser is operating with a substantially dry cathode, meaning no electrolyte is fed into the cathodic half cell.

It is envisaged that the electrochemical stacks or modules may be connected in series or in parallel in each blade, fluidly and/or electrically, and for blades within a group of blades. A group generally comprising electrochemical modules of the same type.

In the preferred embodiment the framework is a housing for each of the blade types. The framework may be purely spatial, in the grouping of components (i.e. in a particular spatial configuration), a literal (i.e. physical) framework, or a more substantial housing. Preferably the framework provides a simplified interface allowing for plug and play architecture. In other words, inlets and outlets may have a single combined port. By way of example a single power supply port for the blade as opposed to a connection for each stack in the blade, or a single waste line etc., the present invention is not intended to be restricted by connector types. The housing may also be weatherproof.

It is envisaged that the framework may allow for strings of stacks to be arranged side by side, or stacked vertically. Regardless of the orientation, it is envisaged that adequate spacing is allowed for ventilation and/or access, or means provided to allow the removal of a component within the blade.

The BoP blades contain differing components whereas the electrochemical blade normally comprises multiples of the same stacks. For vertically stacked arrangements of the BoP blades the heaviest components are generally located lower down at the bottom. For side by side variants no preference is given.

Regardless of the framework, manifold connections for the introduction or removal of fluids, e.g. electrolyte, processed gases, and generated gases, are provided for each component in the electrochemical blade, and a central manifold is provided between electrochemical and BoP blades.

Each electrochemical stack is envisaged to comprise one or more electrochemical cells. Using an AEM electrolyser cell by way of example, each cell will comprise at least: anodic catalyst; membrane electrode assembly (MEA); and, cathodic catalyst wherein the anodic catalyst and cathodic catalysts are separated by the MEA forming respective anodic and cathodic half cells.

The MEA will comprise at least a membrane, but may additionally include any one or more of: cathodic gas diffusion layer (GDL); cathodic microporous layer (MPL); anodic GDL; and anodic MPL.

Whilst a stack may comprise only a single cell, preferably there will be multiple cells in the range of 2-100. More preferably still 10-50, and even more preferably still 15-30. The cells may be in series or parallel connection.

Whilst it is envisaged each electrochemical blade may comprise a single stack, in the preferred embodiment there are 2 or more stacks in each blade. Preferably there are between 2-50 stacks. More preferably still 3-20 stacks and more preferably still between 5-15 stacks. In other embodiments it is envisaged that larger blades may be used such as over 50 stacks.

An alternative measurement for the number of stacks in a blade is the ratio of power consumption per blade for the entire system. Each blade comprising one or more stacks to provide said power. For example—if a system is constructed using electrolysers with a total power consumption of 1 MW, and the ratio is 10:1 (blades:system) and the electrolyser consume 10 kW each there would be 10 blades with 10 stacks (e.g. electrolysers) each wherein each blade has a power consumption of 100 KW. Alternatively the ratio may be between 1:1 and 100:1, or more preferably between 10:1 and 50:1 and more preferably between 25:1 and 45:1

It is envisaged that in a single system there may be blades with varying electrochemical functions. For example, there may be one or more electrolyser blades, one or more electrochemical compressor blades and one or more fuel cell blades. Each type of electrochemical blade will have a corresponding BOP blade type. Compressor blades may run in series or in parallel.

A system comprising electrochemical blades and the corresponding BOP may also be provided with one or more storage and or buffer tanks for generated products.

The exact BOP structure and requirements may vary depending on the nature of the electrochemical stack. By way of example, the requirements for an electrolyser based system are discussed here. Regardless of the nature of the stack, it is preferred that one BOP blade will have the requisite BOP for at least one electrochemical blade.

In an embodiment of the present invention, the BOP blade may comprise any one or more of the following facilities:
Power supply;
Water and/or electrolyte tank;
Product/byproduct processing (hydrogen/oxygen processing);
Waste heat utilisation;
chiller
Electrolyte regeneration means;
Product storage;
Venting;
Sensors;
Flow trackers;
Safety components;
Control system;
Amine/other waste trap

It is envisaged that the power supply may be any suitable power, from any suitable source, albeit preferably renewable. The power may be AC, DC, pulse or reverse pulse.

It is envisaged that the water tank may be used to degas and store electrolyte to be recirculated back to the electrochemical blade.

In a preferred embodiment, the electrolyte is KOH, although alternatives may be used depending on the nature of the electrochemical device. In said preferred embodiment utilising KOH, the temperature of the electrolyte from the electrochemical blade to the BOP blade is above 25° C. but below 100° C. more preferably between 55° C. and 65° C. It is envisaged that the electrolyte from the BOP blade to the electrochemical stack will be between 50° C. and 60° C.

It is envisaged that product/by-product processing may include, drying, compressing and/or purification. In some embodiments, additional blade types may provide one or more of these functions. Therefore one system may comprise two or more electrochemical blade types to provide a complete solution.

In the preferred embodiment, the BOP blade comprises waste heat utilisation functionality by way of heat exchangers, which may also be used for temperature regulation. Waste heat may be used to pre-heat other components in the system, or externally.

Embodiments utilising electrolyte may be provided with means for the regeneration of said electrolyte.

Each BOP blade may be provided with means to store a product, such as metal hydride or compressed containers for the example of hydrogen.

Safety means may also be provided, such as adequate venting/ventilation, temperature and pressure regulatory means and other such components. Sensors may be used to control said safety means, sensors including temperature, pressure, conductivity (for electrolyte), pH (also for electrolyte).

Whilst it is envisaged that each electrochemical blade may have a corresponding BOP blade, it is also envisaged that a manifold and power equivalent may be provided between the electrochemical blades and BOP blades so that in the event of maintenance of one BOP blade, the corresponding electrochemical blade is not rendered redundant and can be serviced by another BOP blade. There may also be back up BOP blades provided to ensure maximum utilisation of electrochemical device operation.

In order to control the devices, computing means, wired or wireless, are provided to allocate power, and determine which blades shall be utilised. Additional computing means may be provided to vary the power consumption of stacks within a blade.

To maximise function the preferred embodiment envisages the system is adapted to allow hot swapping of electrochemical components within a blade. Each blade being provided with means enabling the electrical and fluid isolation of the string such as valves and switch(es) for controlling the power source. Once isolated, one or more stack in the isolated string can be replaced. This mitigates the need for down time, further improving the power utilisation of the system. It is further envisaged that stacks or blades not meeting expected performance characteristics, such as output values, may be adapted to be isolated by the computing means and a prompt sent indicating maintenance is required. Alternatively, each blade itself may be isolated for repair, maintenance, or replacement.

To facilitate hot swapping, installation and general maintenance, each blade, regardless of blade type is provided with a means or mechanism for ease of access such as a rack, or rolling tray or shelf upon which the components may be mounted, slid out and worked upon.

In an embodiment of the present invention some BOP blades may differ for the same type of electrochemical blade. For example an electrolyte regeneration blade may be provided to service multiple electrolyser blades instead of the electrolyte regeneration facility for a single electrolyser blade being in a single BOP blade. The BoP may for example may be in two or more parts. A first part may be located in one location, coupled with one or more electrochemical blades and the second part being in a second separate location etc., These two or more BoP blades constituting the entire BoP being needed to facilitate the working of the electrochemical device or blade. One example would be a power supply unit and control system being coupled with the electrochemical blade and a second BoP blade being for one or more electrochemical blades having electrolyte tanks, pumps, hydrogen treatment and/or storage capabilities.

In an embodiment of the present invention an electrochemical blade and all or some of the BoP blade share the same framework with the all or some of the BoP being housed by the same framework.

Compression blades may increase pressure to over 2000 bar, or between 10 bar and 2000 bar, more preferably between 50 bar and 1500 bar, more preferably still 100 and 1000 bar and even more preferably still between 300 bar and 800 bar. The stacks within a compression blade may be in parallel or series, and the compressor blades themselves may also be in parallel or series.

According to the present invention there is provided a method for operating a modular electrochemical system, said method comprising:
Providing one or more electrochemical blades, wherein each electrochemical blade comprises at least one or more electrochemical stacks, and
Providing one or more BOP blades, wherein each BOP blade houses the BOP for at least one electrochemical stack, wherein
   The or each electrochemical blade(s) is communicably connected to any one of the BOP blades, and vice versa, and
Each blade is provided with a framework, said framework comprising connection ports adapted for communicable connection with one or more corresponding blade, and
Providing computing means for the control of each electrochemical blade and BOP blade.

The preferred embodiments described above apply also for the method. The computing means, and sensor in particular being of use for the control and operation of the modular electrochemical system. Said computing means preferably being adapted such that a user can set pre-determined thresholds for operation.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

The invention also provides a computer program or a computer program product for carrying out any of the methods features described herein, and/or for embodying any of the apparatus features described herein, and a computer readable medium having stored thereon a program for carrying out any of the methods described herein and/or for embodying any of the apparatus features described herein.

To help understanding of the invention, a specific embodiment thereof will now be described by way of example and with reference to the accompanying drawings, in which:

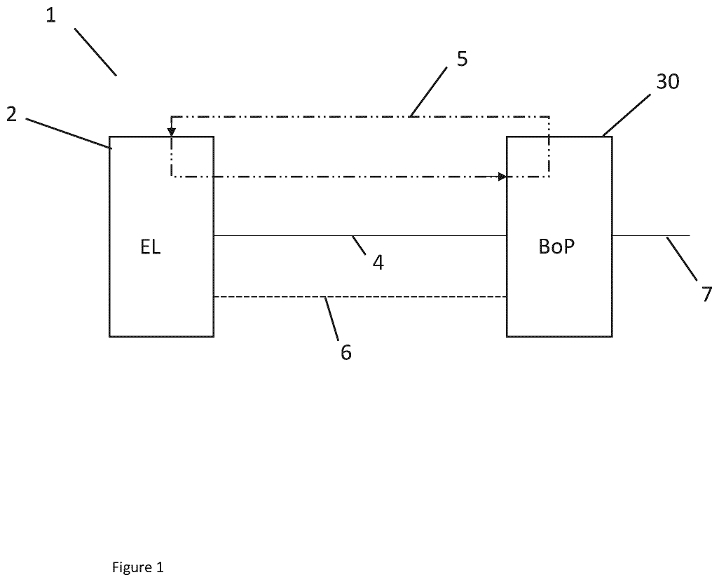

FIG. 1 is a schematic of a single electrolyser blade coupled with a single BOP blade

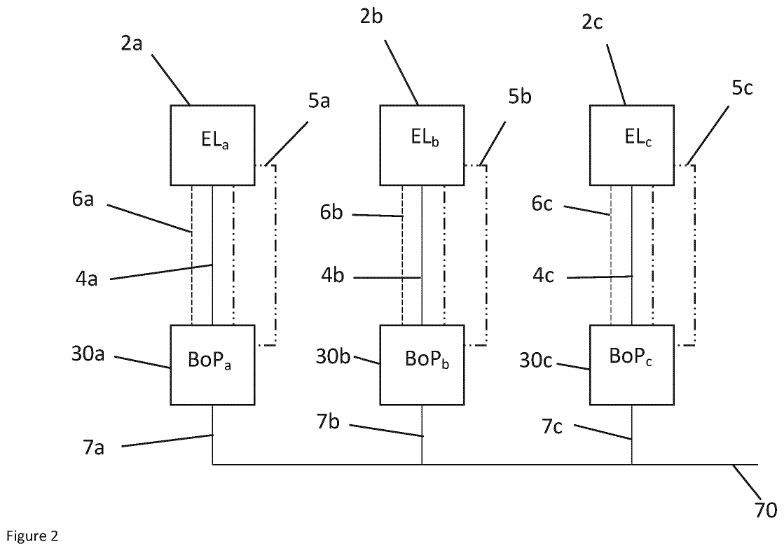

FIG. 2 is a schematic of multiple electrolyser blades coupled to corresponding BOP blades

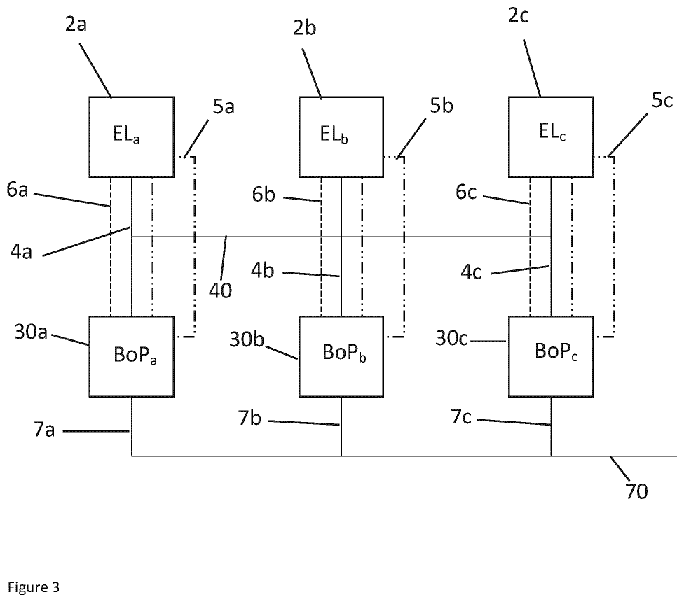

FIG. 3 is a schematic of multiple electrolyser blades coupled to corresponding BOP blades with a manifold

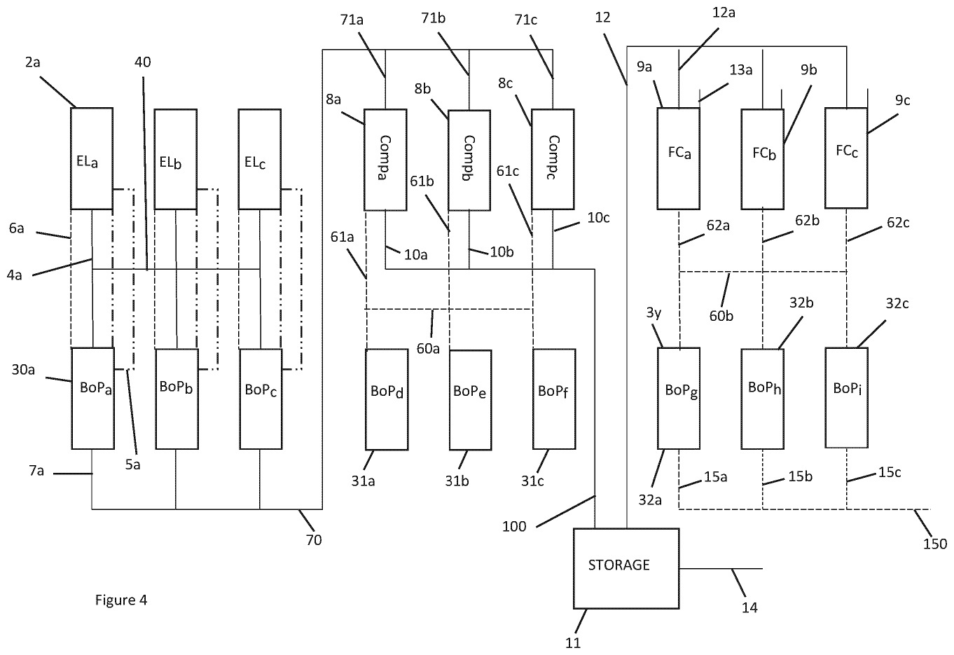

FIG. 4 is a schematic of a hydrogen system comprising multiple types of electrochemical blades with corresponding BOP blades.

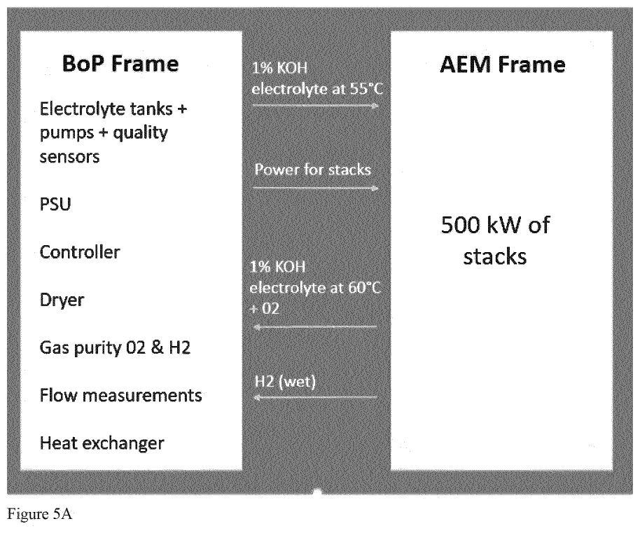

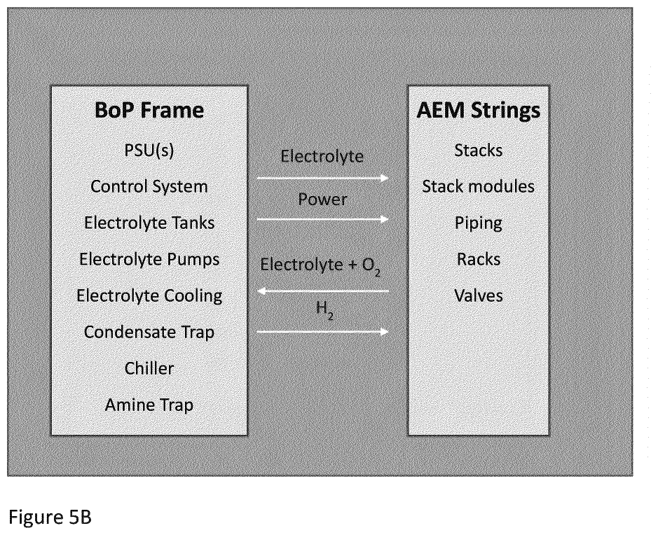

FIGS. 5A and B show an overview of the BOP blade and an AEM blade

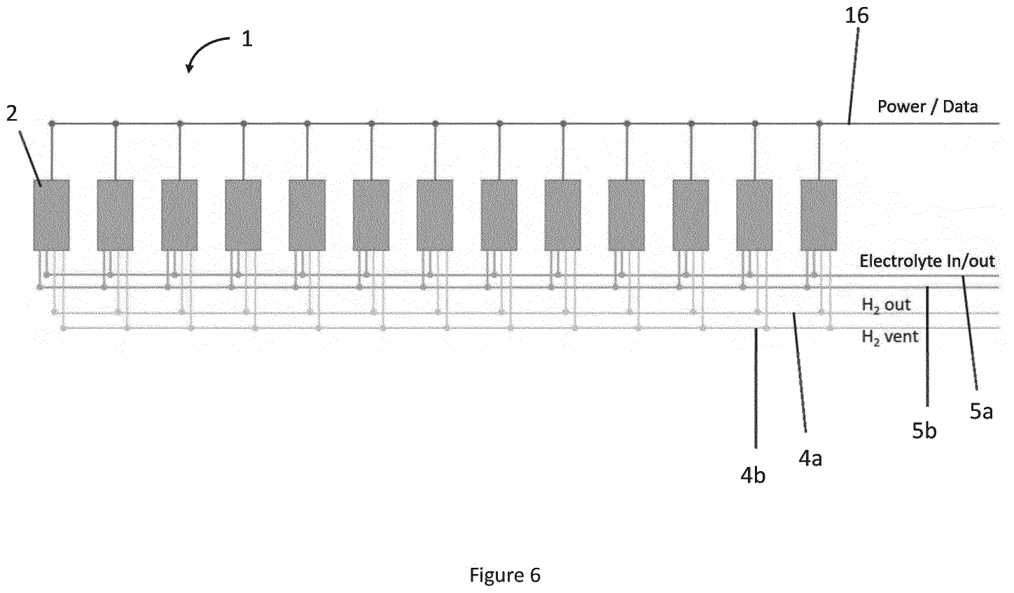

FIG. 6 shows a schematic of a blade in accordance with the present invention

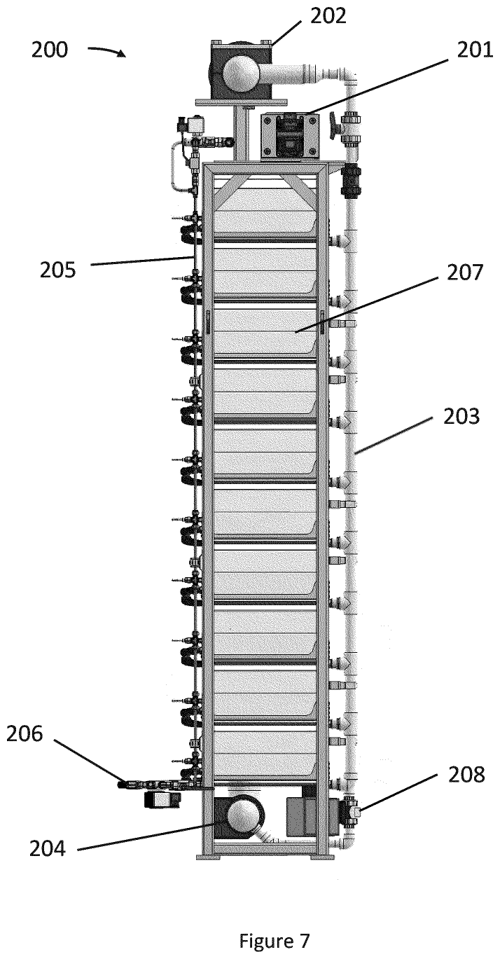

FIG. 7 shows an electrochemical blade with a partial BoP blade

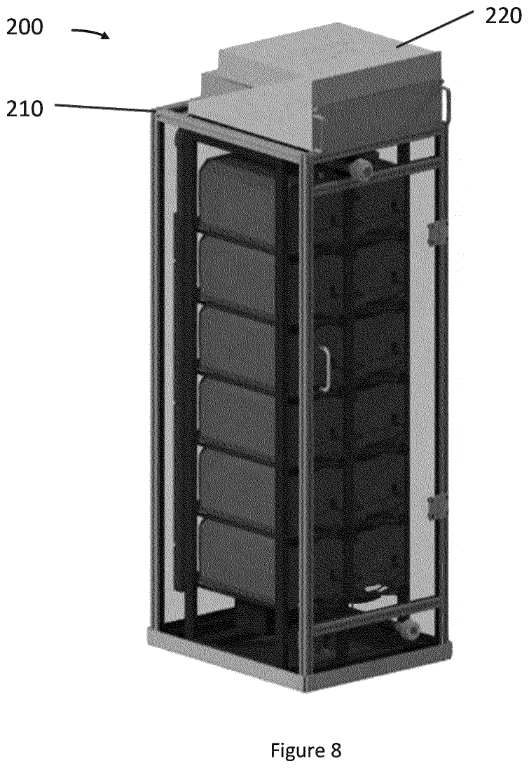

FIG. 8 shows an individual electrochemical blade of FIG. 7

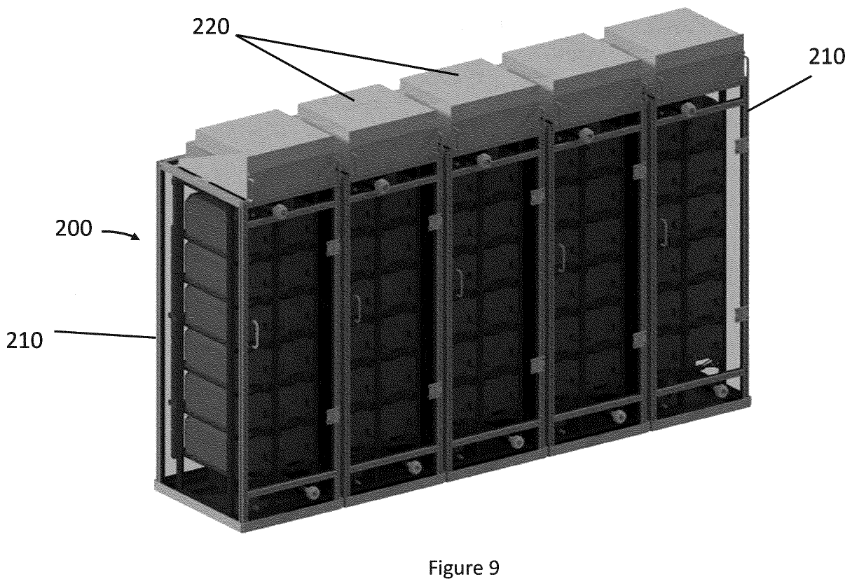

FIG. 9 shows a group of five electrochemical blades of FIGS. 7 and 8

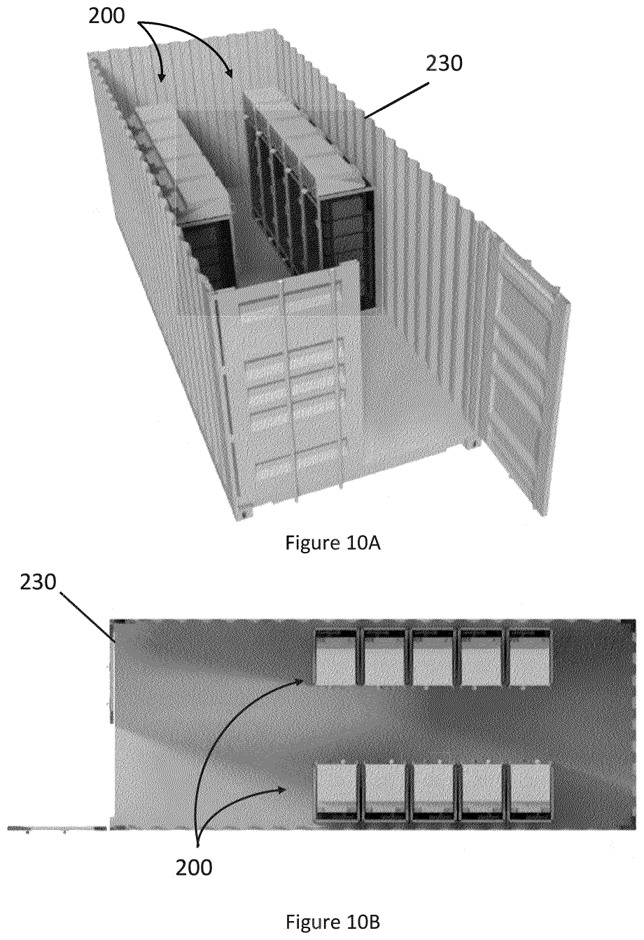

FIGS. 10A and 10B show groups of electrochemical blades arranged within a container.

### DETAILED DESCRIPTION

Referring to FIG. 1 and pair of blades 1 is shown with an electrolyser blade 2 and BOP blade 30. There is piping 4 for the communication of generated hydrogen to the BOP blade 30. Outlet 7 from the BOP takes the hydrogen after processing for use, or storage. The electrolyte loop 5 shows electrolyte moving from the electrolyser blade 2 to the BOP blade 30 and back to the electrolyser blade 2. Not shown are means for regeneration of said electrolyte, a possible component of the BOP blade 30. Another dashed line denotes the power supply 6 from the BOP to the electrolyser blade 2.

Not shown in this or other figures are the computing means, sensor locations or valves for the control of flow of power and fluids between the electrolyser and BOP blades. Vents and disposal for waste products are also not shown.

FIG. 2 shows a schematic of multiple electrolyser blades 2a,b,c and corresponding BOP blades 30a,b,c. also shown are power supplies 6a,b,c hydrogen lines 4a,b,c and electrolyte loops 5a,b,c. the BOP outlets 7a,b,c are optionally combined by a manifold 70 for the communication of product (e.g. processed hydrogen) to the next stage.

FIG. 3 is similar to FIG. 2, but with the addition of hydrogen manifold 40. The presence of hydrogen manifold 40 means that hydrogen produced by any one electrolyser blade may be processed by any one of the BOP blades 30a,b,c thus distributing the processing load between the BOP blades and improving the efficiency of the use of the BOP facilities. Not shown are power “manifolds” and shared electrolyte regeneration, which perform functions in the distribution of power and electrolyte to the electrolyser blades.

FIG. 4 depicts a hydrogen system comprising 3 sets of electrochemical blade types. Following in order of the system electrolyser blades 2 are much as depicted in previous figures, with hydrogen outlet 70 feeding inlets 71a,b,c for compressor blades 8a,b,c respectively. Each of compressor blades 8a,b,c are connected to BOP blades 31a,b,c with a shared power supply meaning any of compressor blades 8a,b,c can be powered or otherwise connected to 31a,b,c.

The hydrogen from the first stage is then optionally compressed and purified by compressor blades 8a,b,c. Shown in stage 2 is a shared power supply 60a (i.e. the power “manifold” not shown in stage 1) meaning the compressor blades 8a,b,c could be powered by any one of BOP blades 31a,b,c. the outlets 10a,b,c from the compressor blades combine to hydrogen line 100 to storage vessel 11. The storage vessel has an outlet 14 for hydrogen to be used as is in industry or for refuelling for example. Alternatively, outlet 12 allows the hydrogen to be used in the final stage fuel cell blades 9a,b,c which generate electricity from the hydrogen. Additional inlet for ambient air/oxygen 13a,b,c are provided the fuel cell blades respectively for use in the electricity generation.

As for previous stages, a shared line 60b allows the generated electricity to be directed from any of the BOP blades 32a,b,c to the fuel cell blades 9a,b,c. The BOP blades 32a,b,c comprising power regulating means, inverters etc. as required for the fuel cells. The generated electricity leaves the BOP by line 15a,b,c and is combined into line 150 for use as required.

In the first stage hydrogen is generated via the electrolysis of water, the produced hydrogen is then compressed and purified by the electrochemical compressor blades in the second stage. The generated hydrogen may then go to a fuel cell after storage/buffer, or be used in industrial processes or for refuelling.

Not shown is the power supply to the BOP blades, as stated above this is preferably renewable.

Referring to FIGS. 5A and 5B, overviews of two blades can be seen with a list of certain features. The electrochemical frame (AEM frame) housing multiple AEM electrolyser stacks and the BOP blade comprising electrolyte tanks, pumps and sensors; power supply unit (PSU); control means; dryer; means for ensuring the purity of the products of the electrolysis; means for measuring flow rate and a heat exchanger.

Whilst in FIGS. 5A and 5B a direct communication between the electrochemical and BOP blades is provided, as mentioned previously a central manifold may be provided.

FIG. 6 shows a schematic of a blade 1 in accordance with the present invention. There are multiple electrochemical modules 2 with a shared connection 16 for power and data, a manifold 5a supplies the electrolyte to each stack 2 in the blade, and another manifold 5b transfers the electrolyte to a BoP blade. An outlet for generated hydrogen 4a is provided along with a hydrogen vent 4b. The electrolyte and hydrogen manifolds are connected to the BoP blade which is not shown.

FIG. 7 shows a rendering of an electrochemical blade 200. This electrochemical blade is accompanied by a power supply unit and data switch 201. A central electrolyte manifold 204 supplies each electrochemical blade in an overall system with the blade specific manifold 203 supplying each stack 207 with electrolyte. The electrolyte return line 202 returns electrolyte from the electrochemical blade to the BoP blade (not shown). Hydrogen generated by each stack is transferred to the BoP blade via the hydrogen manifold 205 through a valve 206 to the central hydrogen manifold.

FIG. 8 shows the electrochemical blade 200 of FIG. 7 in a frame 210 with partial BoP blade 220 on top, the partial BoP blade being a power supply unit and control system. Manifolds and further BoP blades are not shown.

FIG. 9 shows a group of five of the electrochemical blades 200 shown in FIG. 8, each having a frame 210, where a central manifold would be provided for the supply and return of electrolyte and the removal of generated hydrogen.

FIGS. 10A and 10B show various views of the blades 200 in a container 230, which in this example is a shipping container.

It will be understood that the invention has been described above purely by way of example, and modifications of detail can be made within the scope of the invention. In particular, the invention is not intended to be restricted to the details of the above described embodiment. For instance, any number of blades in any number of stages could be present. Each blade may comprise the same or different number of electrochemical modules/stacks. The BOP blades may all be the same or differ to accommodate the needs of the system. Each feature disclosed in the description, and (where appropriate) the claims and drawings may be provided independently or in any appropriate combination. Reference numerals appearing in the claims are by way of illustration only and shall have no limiting effect on the scope of the claims.

1. A modular electrochemical system, said system comprising:
One or more electrochemical blades, wherein each electrochemical blade comprises at least one electrochemical stack, and
One or more balance of plant (BOP) blades, wherein each BOP blade comprises at least one BOP facility for at least one electrochemical stack, wherein:
The or each electrochemical blade(s) corresponds to any one or more of the BOP blades, and vice versa; and
Each electrochemical and/or BOP blade is provided with a framework, said framework comprising at least one port adapted to enable connection with one or more corresponding blades.

2. A modular electrochemical system, as claimed in claim 1 wherein said electrochemical stack(s) in the or each electrochemical blade is any one or more of: an electrolyser, preferably an AEM electrolyser, a fuel cell, a purifier, and/or a compressor.

3. A modular electrochemical system, as claimed in claim 2, wherein said electrochemical stack is an AEM electrolyser operating with a substantially dry cathode.

4. A modular electrochemical system as claimed in claim 1, wherein said electrochemical stacks in a blade are in parallel connection electrically and/or fluidly.

5. A modular electrochemical system as claimed in claim 1, wherein said electrochemical stacks in a blade are in series connection electrically and/or fluidly.

6. A modular electrochemical system as claimed in claim 1, wherein the framework comprises a housing.

7. (canceled)

8. A modular electrochemical system as claimed in claim 1, wherein the at least one ports comprise an inlet and/or outlet, preferably a single inlet and/or outlet, providing a connection between every stack in the electrochemical blade(s) and the at least one BOP facility.

9. A modular electrochemical system as claimed in claim 1, wherein the or each BOP blade provides a single BOP facility for multiple electrochemical blades.

10. A modular electrochemical system as claimed in claim 1, wherein the electrochemical blades are arranged in groups of the same type, preferably wherein each of the blades in a group are in series or parallel connection electrically and/or fluidly.

11. A modular electrochemical system as claimed in claim 1, wherein each electrochemical blade comprises 2 or more electrochemical stacks.

12. A modular electrochemical system as claimed in claim 1, wherein each electrochemical blade constitutes at least 1/100^{th} of the required output from the electrochemical blades.

13. A modular electrochemical system as claimed in claim 1, wherein the BOP blade facilities comprise any one or more of:
Power supply, preferably wherein the power is AD, DC, pulse, or reverse pulse;
Water and/or electrolyte tank;
Product/byproduct processing (hydrogen/oxygen processing);
Waste heat utilisation;
Electrolyte regeneration means;
Product storage;
Venting;
Sensors;
Flow trackers; and/or
Safety components.

14. (canceled)

15. (canceled)

16. A modular electrochemical system as claimed in claim 1, comprising at least one manifold for the fluid and/or electrical connection of electrochemical blades and BOP blades.

17. A modular electrical system as claimed in claim 16, wherein the at least one manifold is arranged to distribute fluid and/or electrical power between the electrochemical blade(s) and/or BOP blade(s), preferably wherein the distribution is based on an available capacity of either the electrochemical blade(s) and/or the BOP blade(s).

18. A modular electrical system as claimed in claim 16, wherein:
one of said manifolds is located downstream of the BOP blade(s) and upstream of the electrochemical blade(s), and is arranged to: collect fluid from the BOP blades(s) and distribute the collected fluid between the electrochemical blade(s); and/or
one of said manifolds is located downstream of the electrochemical blade(s) and upstream of the BOP blade(s), and is arranged to: collect fluid from the electrochemical blades(s) and distribute the collected fluid between the BOP blade(s).

19. A modular electrochemical system as claimed in claim 1, wherein computing means connected to one or more sensors is provided for the selection of blades to be operated and allocation of available power.

20. A modular electrochemical system as claimed in claim 1, wherein means are provided for the electrical and/or fluid isolation of a blade for hot-swapping components.

21. A modular electrochemical system as claimed in claim 1, wherein the blades are arranged in stages, and wherein each stage comprises: at least one electrochemical blade of a different type; and at least one BOP blade having at least one BOP facility corresponding to the electrochemical blade type, preferably wherein the electrochemical blades in each stage are connected in parallel fluidly and/or electrically, and the stages are connected in series fluidly and/or electrically.

22. A modular electrochemical system as claimed in claim 21, wherein the system comprises:
an electrolyser stage comprising at least one electrolyser blade and at least one BOP blade having at least one BOP facility corresponding to the electrolyser blade(s); and
a compressor stage comprising at least one compressor blade and at least one BOP blade having at least one BOP facility corresponding to the compressor blade(s),
the system optionally also comprising: a fuel cell stage comprising at least one fuel cell blade and at least one BOP blade having at least one BOP facility corresponding to the fuel cell blade(s).

23. (canceled)

24. A method for operating a modular electrochemical system, in accordance with claim 1, said method comprising the following steps:
Providing one or more electrochemical blades, wherein each electrochemical blade comprises at least one electrochemical stack, and
Providing one or more BOP blades, wherein each BOP blade comprises at least one BOP facility for at least one electrochemical stack, wherein:
The or each electrochemical blade(s) corresponds to any one of the BOP blades, and vice versa; and
Each electrochemical and/or BOP blade is provided with a framework, said framework comprising at least one port adapted to enable connection with one or more corresponding blades, and
Providing computing means for the control of each electrochemical blade and BOP blade.

25. (canceled)
